(19) United States
(12) Patent Application Publication
(10) Pub. No.: US 2026/0257082 A1
(43) Pub. Date: Sep. 3, 2026

(54) RESCUE STRAP FOR TRANSPORTING A HUMAN

(71) Applicant: Suppression Gear Inc., Port Neches, TX (US)

(72) Inventors: Chad Joseph Dailey, Kansas City, MO (US); Ryan Michael Cummings, Kansas City, MO (US); Alex Christopher Coday, Lees Summit, MO (US); Kristian Bekk Lockridge, Kansas City, MO (US); Paul Michael Verren, Kansas City, MO (US)

(73) Assignee: Suppression Gear Inc., Port Neches, TX (US)

(21) Appl. No.: 19/159,899

(22) PCT Filed: Feb. 27, 2024
(86) PCT No.: PCT/US24/17378

§ 371 Date: Aug. 26, 2025

Related U.S. Application Data
(60) Provisional application No. 63/487,452, filed on Feb. 28, 2023.

(51) Int. Cl. A62B 5/00; A62B 35/00

(52) U.S. Cl. CPC A62B 5/00; A62B 35/0006

(57) ABSTRACT

A rescue strap worn by a human user for transporting a human victim is provided, the rescue strap comprising: a proximal shoulder loop; a distal end strap extending from the proximal shoulder loop, the distal end strap including a distal wrist loop and at least one securing mechanism; the distal end strap extending from the user's first wrist, along the user's first arm, across the user's back, and to the proximal shoulder loop; and the proximal shoulder loop encircling the user's second arm at the second arm's shoulder and under the second arm's armpit. The rescue strap may be worn beneath a user's coat, may optionally be attached to the user's coat, and the distal end strap may be stowed at the coat sleeve cuff. During use, the distal wrist loop (which may extend from the user's coat sleeve cuff) encircles the user's second wrist.

### CROSS-REFERENCE TO RELATED APPLICATIONS

This application claims priority from U.S. Provisional Patent Application No. 63/487,452 filed on Feb. 28, 2023, which is incorporated by reference herein in its entirety.

### BACKGROUND

First responders, security personnel, military personnel, rescue personnel, and the like, are often tasked with evacuating injured individuals from the site of an emergency to a casualty collection point or waiting ambulance for treatment of the individuals'injuries. While devices such as gurneys, stretchers, litters, and similar exist, these devices require either unobstructed flat surfaces upon which to roll (gurney), and/or multiple people to carry the devices with a human in place over debris, rubble, up and down stairs, etc. Additionally, gurneys, stretchers, and litters are varying degrees of large and bulky, and a rescuer already carrying critical entry gear, medical gear, firefighting gear, and the like is not likely to preemptively burden themselves with additional bulky gear if avoidable; a trip back to an emergency vehicle to retrieve such a device is time consuming and perhaps not possible at all. Thus, a quick and ready means of extracting an injured individual from the scene of an emergency (e.g., a building, battlefield, and/or rough outdoor terrain) to safety is desirable.

Some first responders, such as firefighters, may wear devices such as the Morning Pride® Drag Rescue Device manufactured by Honeywell®, in Dayton, Ohio. The Drag Rescue Device (“DRD”) includes shoulder loops that fit around the first responder's arms to form a harness, with a drag strap extending from the harness behind the wearer's head. In this manner, individuals wearing the DRD can themselves be more easily rescued by comrades should the individual wearing the DRD become injured or incapacitated.

However, many and likely most injured victims at the site of an emergency are not going to be wearing a device such as the DRD when first responders arrive at the scene of an emergency, and even if the victim is wearing the DRD, dragging the victim largely relies upon the rescuer's grip strength pulling on the DRD's harness. What is needed is a device that a first responder or other rescuer can wear, either as a separate piece of gear or integrated into the first responder's gear (e.g., integrated into a turnout/bunker coat) that is deployable by the first responder to rescue another individual, regardless of whether that other individual is wearing a device such as the DRD discussed above.

### SUMMARY

In one aspect, a rescue strap for transporting a human is provided, the rescue strap comprising: a proximal shoulder loop; and a distal end strap extending from the proximal shoulder loop, the distal end strap including a distal wrist loop and at least one securing mechanism.

In another aspect, a rescue strap worn by a human user for transporting a human victim is provided, the rescue strap comprising: a proximal shoulder loop; a distal end strap extending from the proximal shoulder loop, the distal end strap including a distal wrist loop and at least one securing mechanism; the distal end strap extending from the user's first wrist, along the user's first arm, across the user's back, and to the proximal shoulder loop; and the proximal shoulder loop encircling the user's second arm at the second arm's shoulder and under the second arm's armpit.

In another aspect, a rescue strap worn by a human user wearing a coat is provided, the rescue strap comprising: a proximal shoulder loop; a distal end strap extending from the proximal shoulder loop, the distal end strap including a distal wrist loop and at least one securing mechanism; the distal end strap extending from the user's first wrist at the user's coat sleeve cuff, along the user's first arm inside the user's coat sleeve, across the user's back under the user's coat, and to the proximal shoulder loop; and the proximal shoulder loop encircling the user's second arm under the user's coat at the second arm's shoulder and under the second arm's armpit.

### BRIEF DESCRIPTION OF THE FIGURES

The accompanying figures, which are incorporated in and constitute a part of the specification, illustrate various example embodiments, and are used merely to illustrate various example embodiments. In the figures, like elements bear like reference numerals.

FIG. 1A illustrates an elevation view of a prior art DRD 100.

FIG. 1B illustrates an elevation view of prior art DRD 100 worn by a user, with the force applied to the drag strap 104 demonstrating how DRD 100 is used to pull the individual wearing it.

FIG. 2A illustrates an individual wearing a rescue strap 210 as well as DRD 100.

FIG. 2B illustrates rescue strap 210 in a partially deployed state, extending from a cuff 222 of a coat 220, including fields of hook and loop fastener 216, 218 arranged to fix rescue strap 210 to coat 220 when stowed.

FIG. 2C illustrates a rescue strap 210 in a stowed state, tucked inside cuff 222 of coat 220.

FIG. 2D illustrates rescue strap 210, including a proximal shoulder loop 212, a distal end strap 214, and a distal wrist loop 224.

FIG. 2E illustrates rescue strap 210 used with DRD 100 and fitted to an individual.

FIG. 2F illustrates rescue strap 210 used with DRD 100 and fitted to an individual.

FIG. 2G illustrates rescue strap 210 used with DRD 100 and fitted to an individual.

FIG. 2H illustrates rescue strap 210 in a stowed state, extending from cuff 222 and folded back and fixed to coat 220.

FIG. 2I illustrates rescue strap 210 in a partially deployed state, extending from cuff 222.

FIG. 2J illustrates rescue strap 210 in a deployed state, extending from cuff 222 of a first arm 223, and over the wrist of a second arm 225, allowing the user to maintain a more secure and less exhausting grip around the torso of a victim (not shown).

FIG. 2K illustrates rescue strap 210 in a deployed state, extending from cuff 222 of a first arm 223, and over the wrist of a second arm 225, allowing the user 230 to maintain a more secure and less exhausting grip around the torso of a victim 232.

FIG. 3A illustrates a rescue strap 310, including a proximal shoulder loop 312, a distal end strap 314, and a distal wrist loop 324.

FIG. 3B illustrates a distal end strap 314 of rescue strap 310, including corresponding magnets 340, 342 in a deployed state, which are used to maintain rescue strap 310 in a stowed position.

FIG. 3C illustrates distal end strap 314 of rescue strap 310, including corresponding magnets to maintain rescue strap 310 in a stowed position.

FIG. 3D illustrates distal end strap 314 of rescue strap 310, including corresponding magnets, with a first magnet 340 on an outside side of a sleeve of coat 220, and a second magnet (not shown) on an inside side of the sleeve to maintain rescue strap 310 in a stowed position.

FIG. 4A illustrates a perspective view of a distal end strap 414 of a rescue strap 410 including corresponding magnets 440, 442 in a deployed state.

FIG. 4B illustrates an elevation view of distal end strap 414 of rescue strap 410, including corresponding magnets 440, 442 in a stowed state.

FIG. 4C illustrates a perspective view of distal end strap 414 of rescue strap 410, including corresponding magnets 440, 442 in a stowed state.

FIG. 4D illustrates a perspective view of distal end strap 414 of rescue strap 410, including corresponding magnets 440, 442 in a stowed state, wherein magnet 440 is on the outside of a sleeve of a coat 420 and magnet 442 is on the inside of the sleeve.

FIG. 4E illustrates a perspective view of distal end strap 414 of rescue strap 410, including corresponding magnets 440, 442 in a stowed state, wherein magnet 440 is on the outside of a sleeve of coat 420 and magnet 442 is on the inside of the sleeve.

FIG. 5A illustrates a perspective view of a distal end strap 514 of a rescue strap 510 in a partially deployed state, including fields of hook and loop fastener 516, 518 arranged to fix rescue strap 510 to a coat 520 when stowed.

FIG. 5B illustrates a perspective view of distal end strap 514 of a rescue strap 510 a stowed state, including fields of hook and loop fastener 516, 518 arranged to fix rescue strap 510 to a coat 520 when stowed.

FIG. 6A illustrates a perspective view of a distal end strap 614 of a rescue strap 610 in a stowed state, including one or more bendable or spring wire 650.

FIG. 6B illustrates a perspective view of a distal end strap 614 of a rescue strap 610 in a stowed state, including one or more bendable or spring wire 650, wherein the distal end strap 614 extends along an inside side of a sleeve us a coat 620, folds over at a cuff 622, and extends along a portion of an outside side of coat 620.

FIG. 7 illustrates a rescue strap 710 integrated into a coat 720 between an outer layer 760 and an inner layer 762.

FIG. 8 illustrates a prior art DRD 800 oriented within a coat 820.

FIG. 9 illustrates a coat 820 including both a rescue strap 910 as well as DRD 800.

FIG. 10 illustrates a user 1030 using a rescue strap 1010 engaged with a victim 1032's drag handle (not shown).

FIG. 11 illustrates a rear view of a user 1130 using a rescue strap 1110 to maintain a more secure and less exhausting grip around the torso of a victim 1132.

FIG. 12 illustrates a user 1230 using a rescue strap 1210 engaged with a victim 1232's leg 1280.

FIG. 13 illustrates a user 1330 using a rescue strap 1310 engaged with a victim 1332's arms 1382.

FIG. 14 illustrates rescue strap 1410 in a deployed state, extending from first arm 1423, and over the wrist of a second arm 1425, allowing the user 1430 to maintain a more secure and less exhausting grip around the torso of a victim 1432.

### DETAILED DESCRIPTION

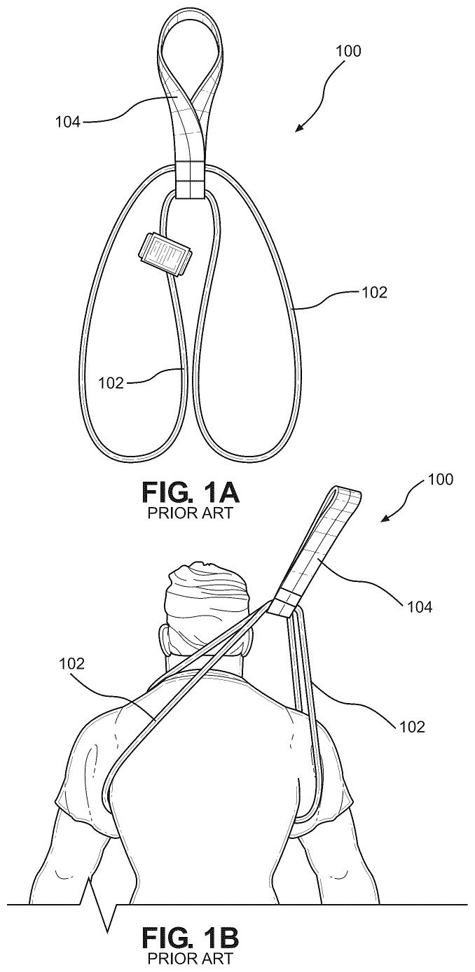

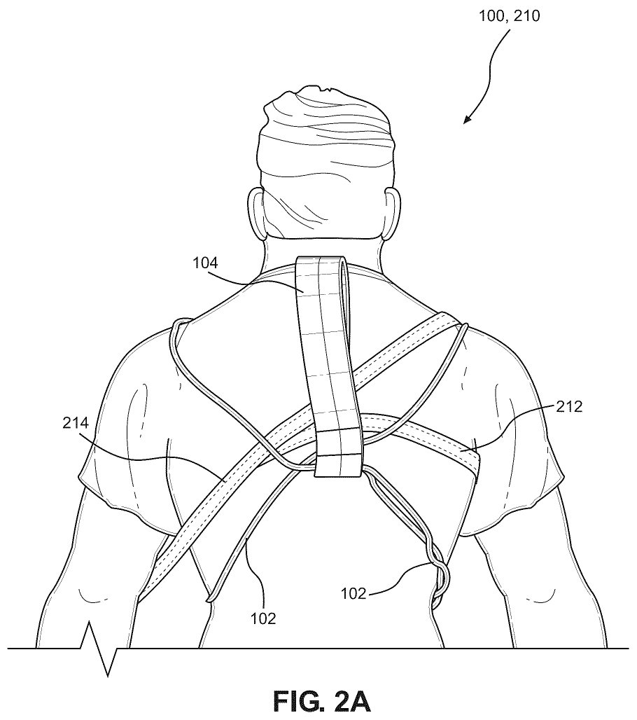

FIGS. 1A and 1B illustrate a prior art DRD 100, including dual shoulder loops 102 connected to a drag strap 104. Each of the shoulder loops 102 is oriented about a wearer's arms, extending below the wearer's armpits and over the wearer's shoulders. Shoulder loops 102 are gathered and connected to drag strap 104 oriented behind the wearer's head/neck. In the event that the wearer is injured and/or incapacitated and needs to be retrieved by other personnel, the other personnel can access drag strap 104 and use drag strap 104 to pull/drag the injured individual from danger.

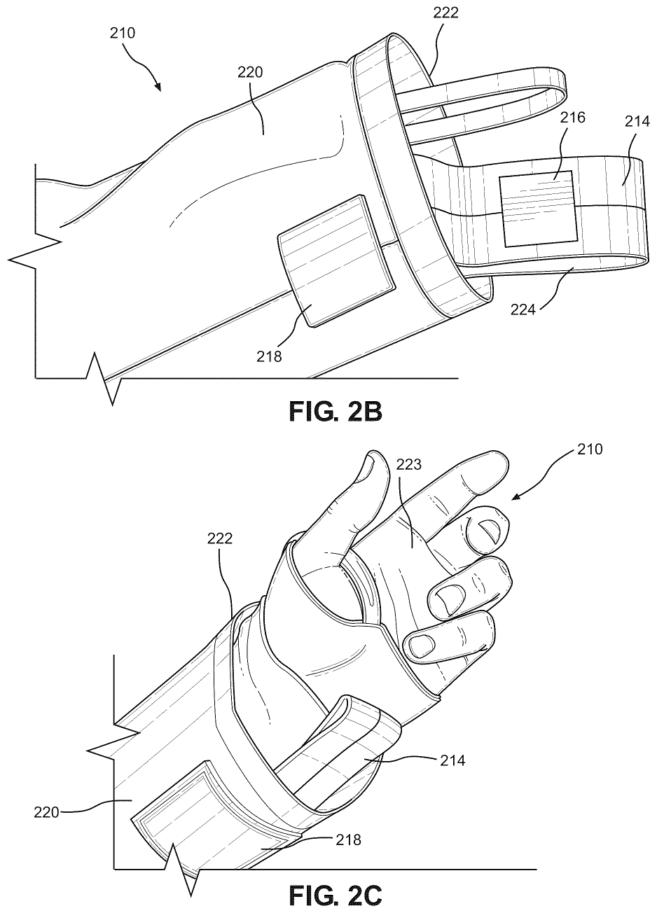

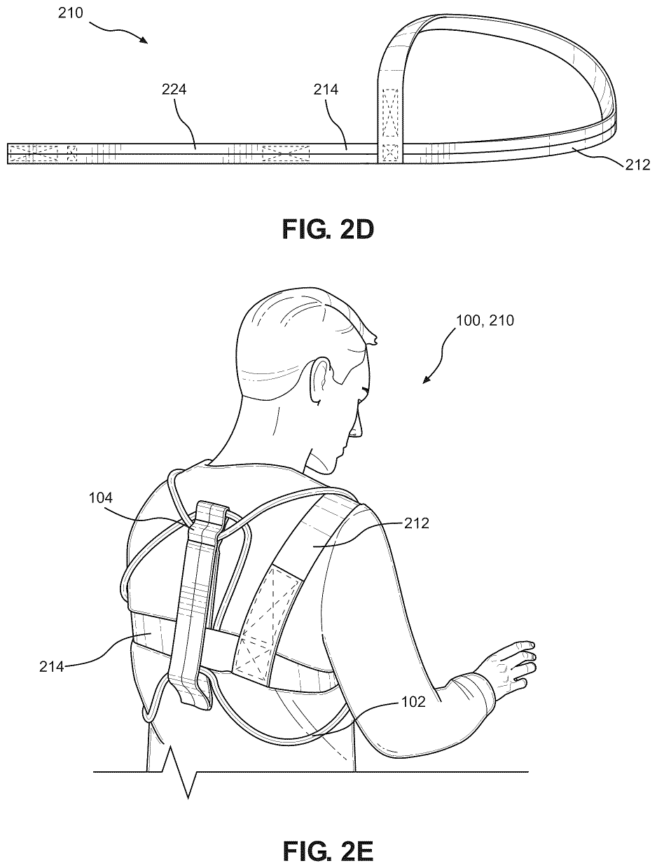

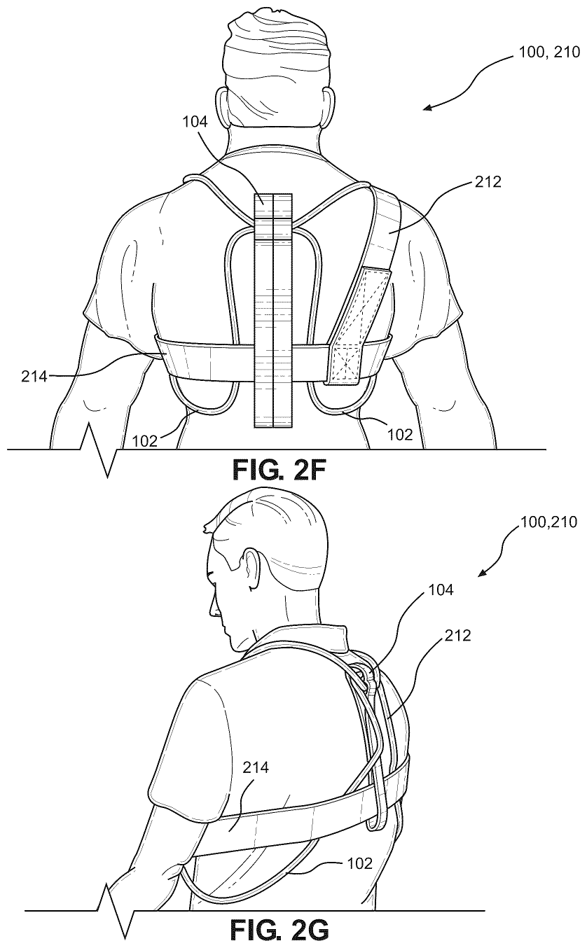

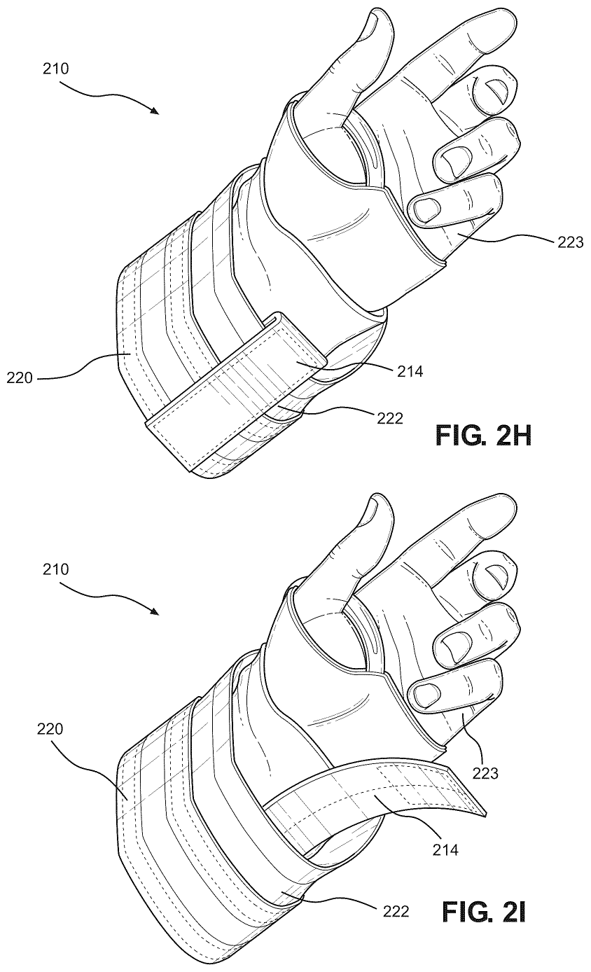

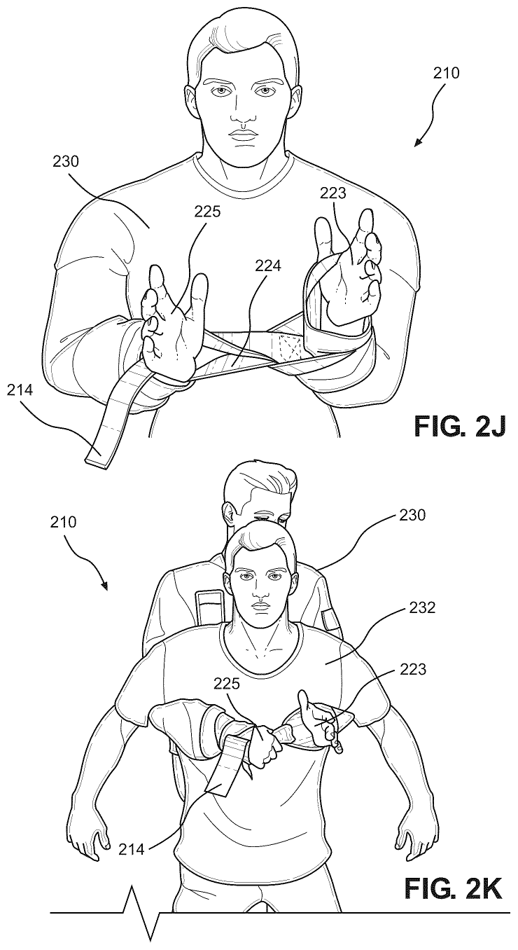

FIGS. 2A-2K illustrate a rescue strap 210. Rescue strap 210 includes a proximal shoulder loop 212 and a distal end strap 214 extending from proximal shoulder loop 212. Distal end strap may include a distal wrist loop 224. Distal end strap 214 may include a securing mechanism.

Rescue strap may be formed from any of a variety of pliable materials of sufficient strength, including for example webbing formed from nylon or another polymer. The materials used to make rescue strap 210 may be fire resistant materials.

FIG. 2A illustrates an individual wearing rescue strap 210 as well as DRD 100. Both rescue strap 210 and DRD 100 may be worn about a wearer's body, independent from the wearer's garment (e.g., turnout coat). Alternatively, rescue strap 210 may be integrated into the wearer's garment (e.g., turnout coat) via permanent stitching or otherwise fastening rescue strap 210 to the wearer's garment, including on an inside surface or outside surface of the wearer's garment, or between layers of the wearer's garment.

FIG. 2B illustrates rescue strap 210 in a partially deployed state, extending from a cuff 222 of an upper body garment, such as a coat 220, including fields of hook and loop fastener 216, 218 arranged to fix rescue strap 210 to coat 220 when stowed. Rescue strap 210 must remain in its stowed position during at least reasonable movement and activities of the wearer, such that rescue strap 210 does not become partially or completely deployed when not needed and interfere with the wearer's activities. Thus, various mechanisms are included herein for securing rescue strap 210 in a stowed position. Rescue strap 210 includes a wrist loop 224 as described below.

FIG. 2C illustrates a rescue strap 210 in a stowed state, tucked inside cuff 222 of coat 220. Distal end strap 214 may include a securing mechanism such as hook and loop fields, snaps, magnets (as described below), or bendable or spring wires (as described below) to keep rescue strap 210 in its stowed position when not in use.

While it is important that rescue strap 210 remain in its stowed position when not in use, any securing mechanism must also allow the wearer to quickly deploy rescue strap 210 when rescue strap 210 is to be used. In the event of general physical trauma, fire, earthquakes, battlefields, and the like, quickly moving a casualty from the danger zone to a safe area can be crucial in the saving of the casualty's life. As illustrated, rescue strap 210 may be arranged within a sleeve of coat 220 surrounding a user's first arm 223.

FIG. 2D illustrates rescue strap 210, including a proximal shoulder loop 212, a distal end strap 214, and a distal wrist loop 224.

Shoulder loop 212 encircles a user's arm, for example the right arm, running both below the user's armpit and over the user's shoulder.

Distal end strap 214 extends from shoulder loop 212 across the user's back at or near the trapezius muscles, to the user's opposite (e.g., left) arm, shoulder, or armpit. Distal end strap 214 runs along the user's arm (e.g., left arm) to the user's wrist and hand (e.g., left wrist and hand).

While the user's left arm and right arm are used herein as an example, rescue strap 210's shoulder loop 212 encircles a user's arm (e.g., right arm), while distal end strap 214 exits near the user's opposite arm's wrist (e.g., left arm). It is possible for a user to wear rescue strap 210 with distal end strap 214 extending from either the left wrist or right wrist as desired by the user, but in either configuration shoulder loop 212 must encircle the shoulder and armpit of the opposite arm.

FIGS. 2E-2G illustrate rescue strap 210 fitted to an individual with shoulder loop 212 mounted to the individual's right arm, and distal end strap 214 extending along the individual's left arm, as described above.

FIG. 2H illustrates rescue strap 210 in a stowed state, extending from cuff 222 and folded back and fixed to coat 220, while FIG. 2I illustrates rescue strap 210 in a partially deployed state. In the illustrated example, distal end strap 214 exits cuff 222 at the hand of user's left arm/first arm 223. Any of a variety securing mechanisms as described herein may be used to maintain distal end strap 214 temporarily secured to coat 220 near cuff 222 in its stowed position.

Some coats, such as certain turnout/bunker coats, have waterproof wristlets that may prevent the stowing of rescue strap 210 in the arrangement illustrated, where it extends from cuff 222 and folds back along the outside of coat 220. In that instance, a securing mechanism may be used to secure distal end strap 214 within an inner surface of the coat sleeve, just inside cuff 222 where it can be accessed when needed. Alternatively, a tunnel may be formed within the waterproof wristlet allowing distal ends strap 214 to pass through cuff 222 between the outer layer of coat 220 and the waterproof wristlet itself. FIGS. 2B, 2C, 2H, and 2I illustrate embodiments where distal end strap 214 is allowed to pass through an area between the outer surface of coat 220 and an inner sleeve extending further than cuff 222 to provide additional protection to the wearer.

FIGS. 2J and 2K illustrate rescue strap 210 in a deployed state, extending from cuff 222 of a first arm 223, and encircling the wrist of a second arm 225, allowing the user 230 to maintain a more secure and less physically exhausting grip around the torso of a victim 232. In these examples, user 230 is either part of a team of two utilizing the two-person extremity carry/fore-and-aft carry techniques, or is individually applying a one-person drag/carry technique such as the cradle-drop drag technique.

In either technique, user 230 of rescue strap 210 approaches victim 232 from behind, and extends user 230's arms under victim 232's armpits to grasp victim 232's upper torso, and thereafter moves victim 232. Where user 230 is able to, depending upon the size of user 230's arms and the size of victim 232's torso, user 230 may interlock user 230's fingers or otherwise grasp one of user 230's hands with the other, removing some of the physical burden on user 230's arms during the carry/drag.

Rescue strap 210 may include a distal wrist loop 224, which user 230 may extend over the wrist of user 230's second arm 225, lessening the physical burden on both user 230's arms and hands during the carry/drag. Additionally, where user 230's arm size, and victim 232's torso size, do not allow user 230 to physically reach user 230's opposite hand during the carry/drag, distal wrist loop 224 may form the extension necessary to allow user 230 to physically join user 230's hands on victim 232's chest, again significantly lessening the physical burden on user 230's arms. User 230 may grasp distal end strap 214 with user 230's hands, including at or near distal wrist loop 224, to provide user 230 with a more secure grip during use of rescue strap 210 and/or to ensure that user 230's hand (of second arm 225) does not slip out of wrist loop 224.

By lessening the physical burden on user 230's muscles, rescue strap 210 may allow user 230 to remain in the carry/drag position for a longer period of time than user 230 may otherwise be physically able to, permitting user 230 to remove victim 232 further to safety, over rougher terrain, and/or to rescue multiple victims 232 all due to the decreased fatigue resulting from the lower physical burden. Additionally, a smaller, weaker user 230 may use rescue strap 210 to carry a larger, heavier victim 232 than user 230 may otherwise be able to.

As illustrated in FIG. 2J, wrist loop 224 may be formed from two thicknesses of material that are not stitched to one another over an appropriate length to permit user 230 to insert user 230's hand into the loop formed between the two thicknesses of material. Wrist loop 224 may be oriented at the distal terminus of distal end strap 214. Wrist loop 224 may be oriented near the distal terminus of distal end strap 214. Distal end strap 214 may continue past the distal end of wrist loop 224, and this portion of distal end strap 214 may include part or all of the securing mechanism.

As illustrated in FIG. 2K, user 230 is able to grasp the comparatively smaller distal end strap 214 in the vicinity of wrist loop 224 with the hand of user 230's second arm 225 to provide a much more secure grip on victim 232's torso as opposed to simply grasping the opposite hand (if physically possible, as described above). This is particularly true wherein one or both of user 230's hands may be wet, sweaty, bloody, or otherwise slippery, or may be covered with bulky gloves. User 230 may additionally grasp distal end strap 214 with the hand of user 230's first arm 223, including at or near wrist loop 224, for the same effect as described above.

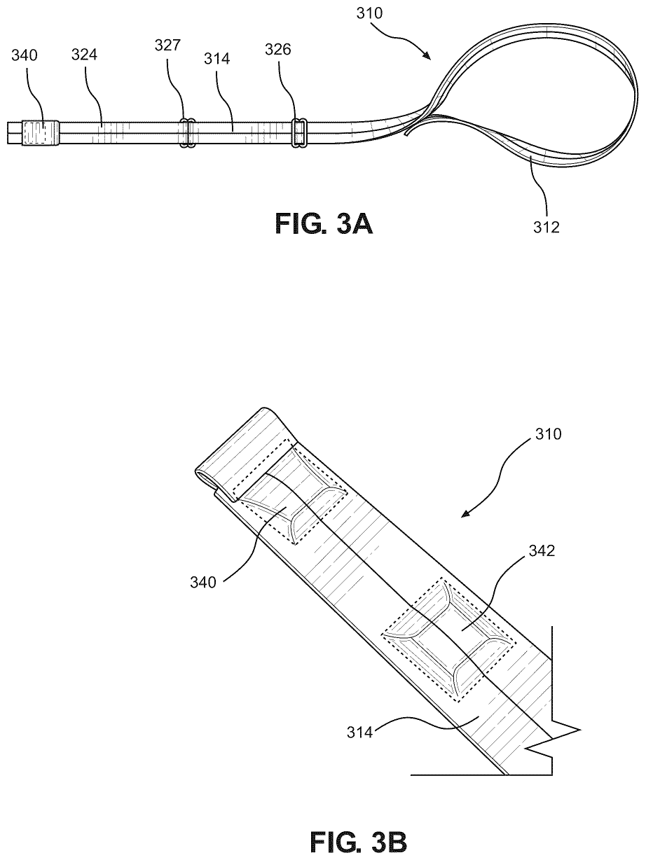

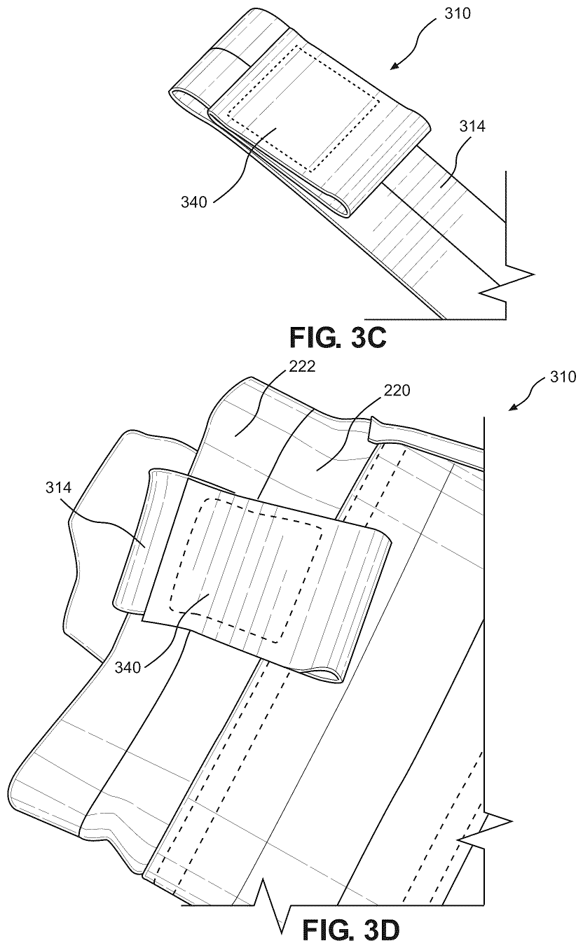

FIGS. 3A-3D illustrates a rescue strap 310, including a proximal shoulder loop 312 a distal end strap 314 extending from proximal shoulder loop 312, distal end strap 314 including a distal wrist loop 324. The length of distal end strap 314 may be adjusted using an adjustment mechanism such as a tri-glide buckle 326 capable to adjusting more or less of distal end strap 314 extending through a corresponding pass through buckle 327. This length may be adjusted to fit users of varying sizes.

Distal end strap 314 includes corresponding magnets 340, 342 spaced apart from one another and configured to engage one another through coat 220. Distal end strap 314 may extend from cuff 222 and fold back upon itself outside of coat 220, with magnet 340 being outside of coat 220 and magnet 342 being inside of coat 220.

Wrist loop 324 may be formed as two layers of material between pass through buckle 327 at wrist loop 324's proximal end, and stitching at wrist loop 324's distal end. The unstitched gap between the two layers of material may form wrist loop 324.

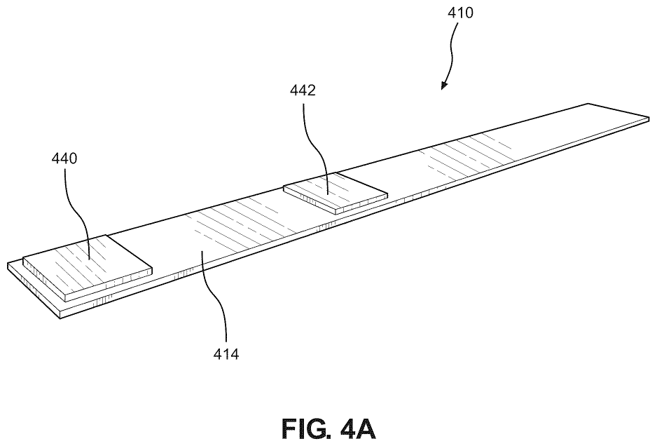

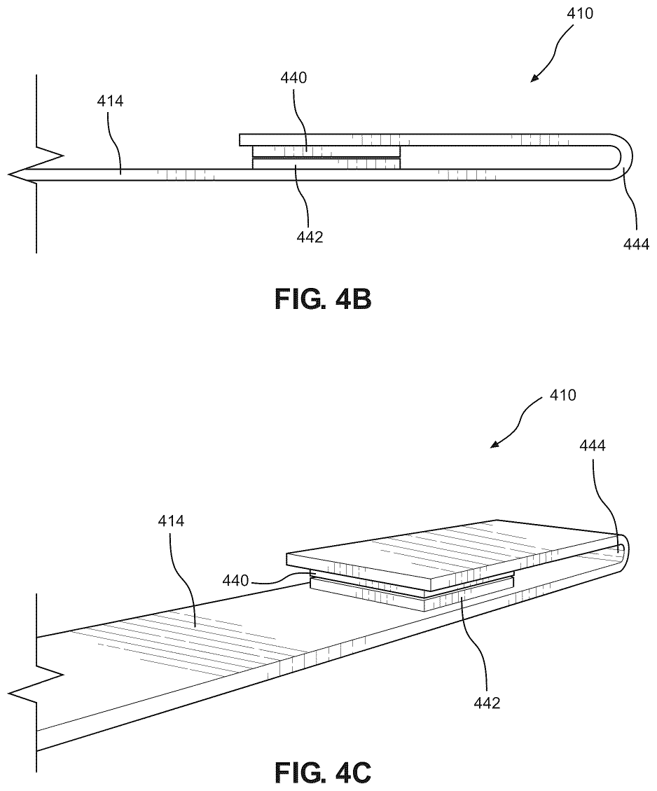

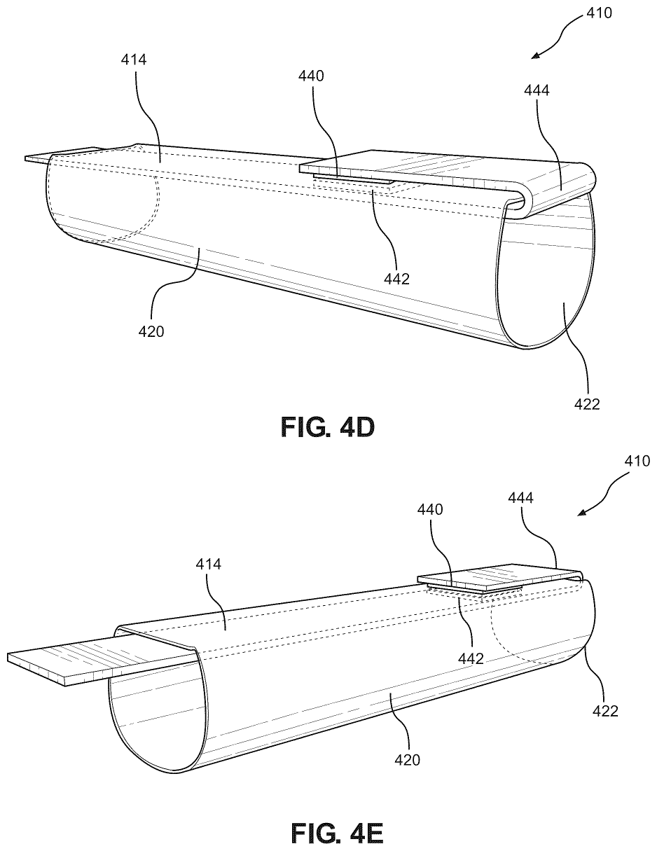

FIGS. 4A-4E illustrate a distal end strap 414 of a rescue strap 410, including corresponding magnets 440, 442. Distal end strap 414 may extend from within a sleeve of an upper body garment, such as a coat 420, via a cuff 422. Distal end strap 414 may fold at a crease 444 back upon itself, allowing magnets 440 and 442 to engage with one another through the material of coat 420. Magnets 440, 442 may be strong enough to maintain distal end strap 414 in a stowed position, while allowing a user to easily and quickly deploy rescue strap 410 when needed by simply pulling distal end strap 414 away from its stowed position.

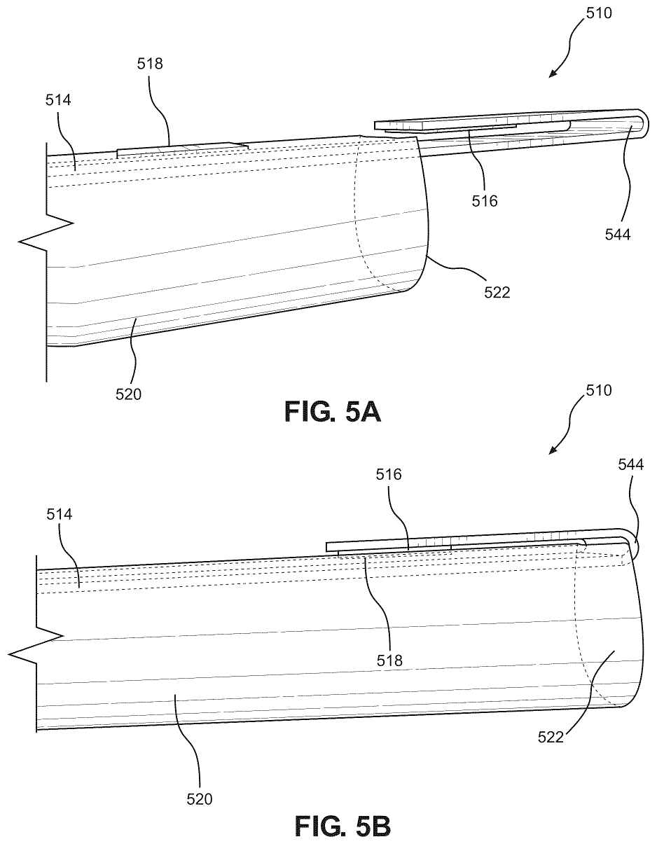

FIGS. 5A-5B illustrate a distal end strap 514 of a rescue strap 510, including fields of hook and loop fastener 516, 518 arranged to fix rescue strap 510 to an upper body garment, such as a coat 520 when stowed. Distal end strap 514 may extend from within a sleeve of a coat 520, via a cuff 522. Distal end strap 514 may fold at a crease 544 back upon itself, allowing a first field of a hook and loop fastener 516 set to engage a second field of a hook and loop fastener 518 set. Hook and loop fasteners 516, 518 may be strong enough to maintain distal end strap 514 in a stowed position, while allowing a user to easily and quickly deploy rescue strap 510 when needed by simply pulling distal end strap 514 away from its stowed position.

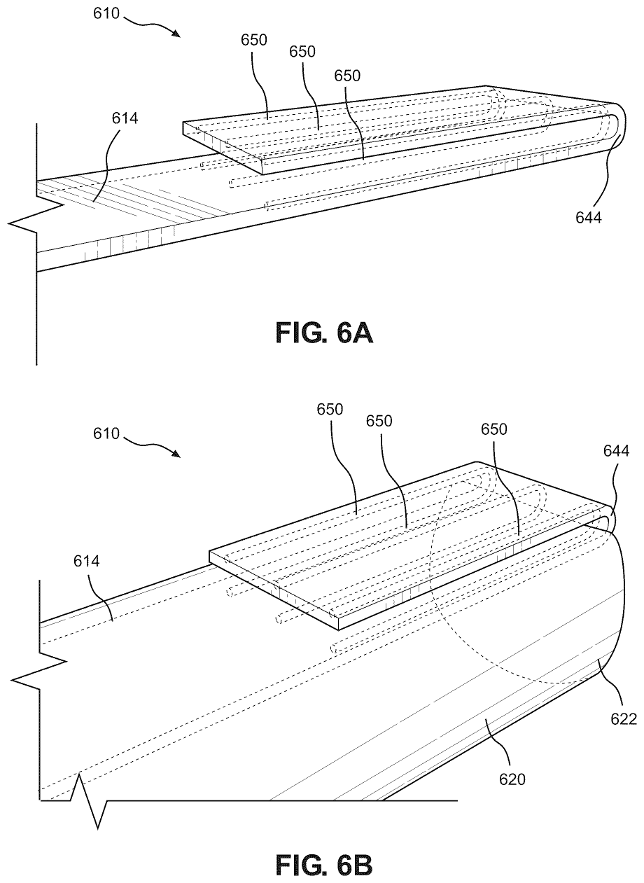

FIGS. 6A-6B illustrates a distal end strap 614 of a rescue strap 610, including one or more bendable or spring wire 650 arranged to fix rescue strap 610 to an upper body garment, such as a coat 620 when stowed. Distal end strap 614 may extend from within a sleeve of a coat 620, via a cuff 622. Distal end strap 614 may fold at a crease 644 back upon itself, and may be held in place in the folded position by wires 650.

Wires 650 may be bendable wires, and able to stay in a bent or straight position as manipulated by the user similar to a twist-tie on a bread bag. A user may bend wires 650 into position to create a clamping effect upon the sleeve of coat 620. When deploying rescue strap 610, a user simply grasps the distal end of distal end strap 614 and pulls it away from coat 620 into a deployed position.

Alternatively, wires 650 may be spring wires, configured to remain in a bent position and essentially creating a clamping effect upon the sleeve of coat 620. When deploying rescue strap 610, a user simply grasps the distal end of distal end strap 614 and pulls it away from coat 620 into a deployed position.

Wires 650 may be integrally formed with distal end strap 614 or fixed to a surface of distal end strap 614. Wires 650 may be stitched between two layers of material forming distal end strap 614, with the stitching maintaining wires 650 in a desired position. Alternatively, wires 650 may be instead replaced with a flat layer of metal, such as a section of flat stock formed from bendable steel or spring steel.

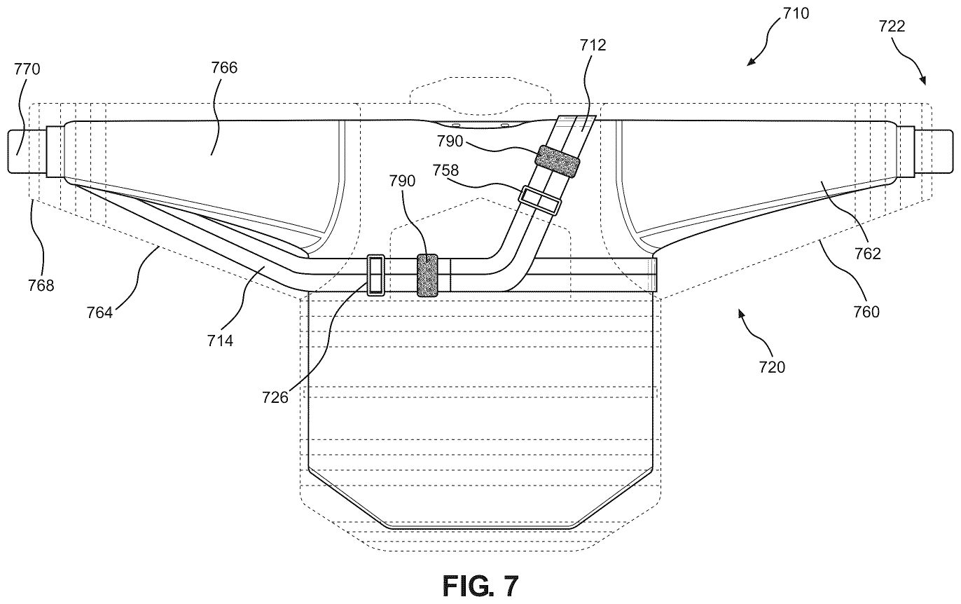

FIG. 7 illustrates a rescue strap 710 integrated into an upper body garment, such as a coat 720 between an outer layer 760 and an inner layer 762. Coat 720 may include at least two layers. Outer layer 760 is shown in phantom to provide the reader with a clear view of inner layer 762 and rescue strap 710 applied over inner layer 762 and under outer layer 760.

Rescue strap 710 includes a proximal shoulder loop 712 and a distal end strap 714 extending therefrom. Rescue strap 710 may include a tri-glide buckle 726 to adjust the length of distal end strap 714. Rescue strap 710 may include a tri-glide buckle 758 to allow a user to selectively adjust the length of shoulder loop 712.

Outer layer 760 may be the outer layer of a protective coat, including for example a turnout/bunker coat worn by firefighters. Outer layer 760 may include outer sleeves 764 and outer cuffs 768.

Inner layer 762 may be the inner layer of a protective coat. Inner layer 762 may include inner sleeves 766 and inner cuffs 770.

Shoulder loop 712 encircles one of inner sleeves 766 (e.g., right sleeve) while end strap 714 extends across the back of inner layer 762 at or near the wearer's trapezius muscles, to the opposite (e.g., left) inner sleeve. Distal end strap 714 runs along the aforementioned opposite (e.g., left) inner sleeve 766, to exit cuff 722 on the outside of inner cuff 770. Outer layer 760 is positioned outside of rescue strap 710 and inner layer 762, such that end strap 714 exits cuff 722 between inner cuff 770 and outer cuff 768.

In one aspect, rescue strap 710 is integrally connected to (e.g., sewn to, glued to, formed as a part of, and the like) one of inner layer 762 (outside of inner layer 762) or outer layer 760 (inside of outer layer 760). In another aspect, rescue strap 710 is removably connected to one of inner layer 762 (outside of inner layer 762) or outer layer 760 (inside of outer layer 760) via one or more retainer 790. One or more retainer 790 may include hook and loop tabs/straps, solid loops sewn into coat 720 (similar to belt loops on pants), straps with buttons or snaps, hook and loop fields on portions of rescue strap 710 that mate with hook and loop fields secured to coat 720, or the like.

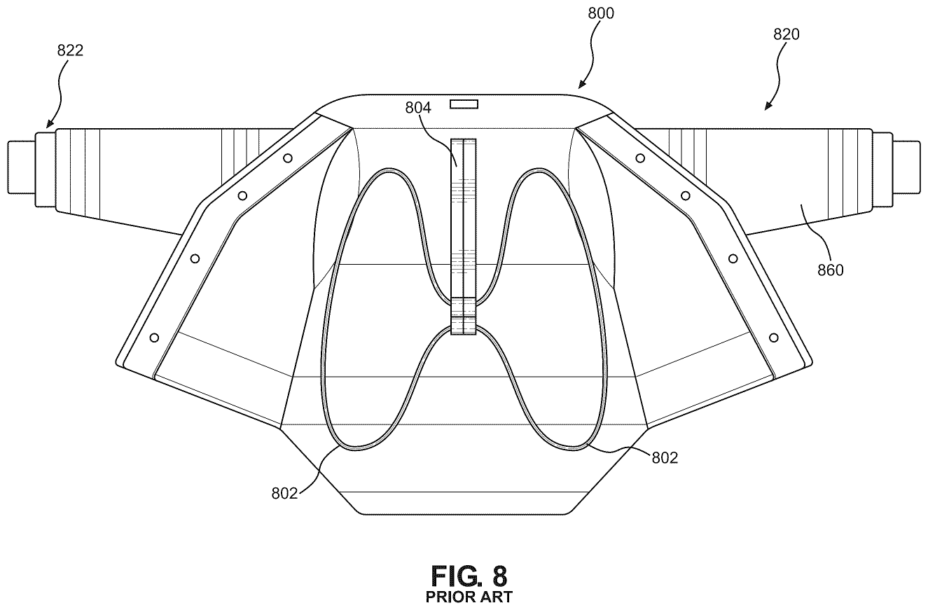

FIG. 8 illustrates a prior art DRD 800 oriented within an upper body garment, such as a coat 820. Coat 820 includes an outer layer 860 and cuff 822. DRD 800 includes shoulder loops 802 and a drag strap 804.

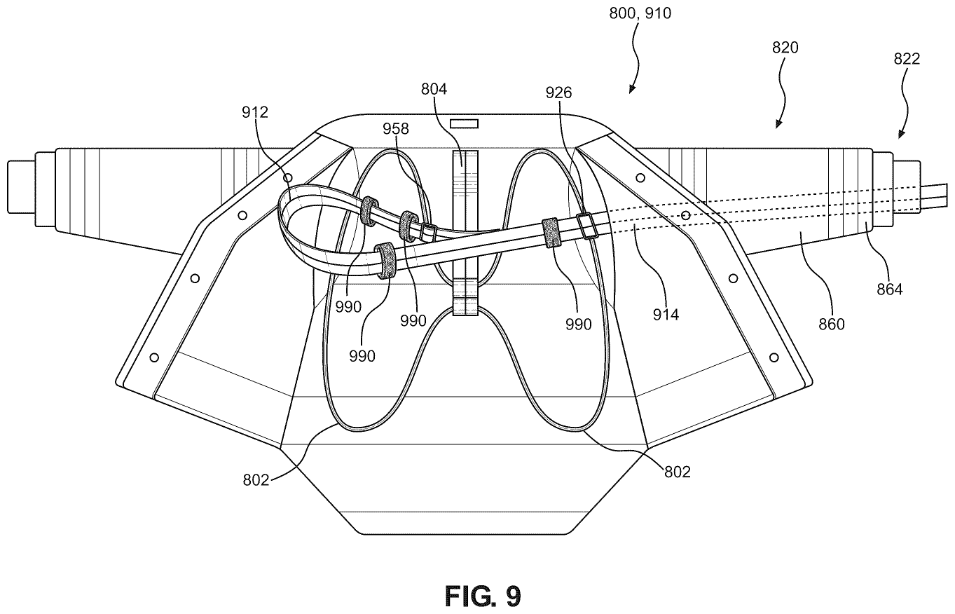

FIG. 9 illustrates a coat 820 including both a rescue strap 910 as well as DRD 800. DRD 800 includes shoulder loops 802 and a drag strap 804.

Rescue strap 910 includes a shoulder loop 912 with an end strap 914 extending therefrom. Shoulder loop 912 may include a tri-glide buckle 958 to allow a user to selectively adjust the size of shoulder loop 912 to accommodate users of different sizes. End strap 914 may include a tri-glide buckle 926 to adjust the length of end strap 914 to accommodate users of different sizes. End strap 914 extends down an interior of an outer sleeve 864, inside of outer layer 860 of coat 820. End strap 914 exits cuff 822 and can be deployed from there, or secured there, as described above.

In one aspect, rescue strap 910 is integrally connected to (e.g., sewn to, glued to, formed as a part of, and the like) the inside of coat 820. In another aspect, rescue strap 910 is removably connected to the inside of coat 820 via one or more retainer 990. One or more retainer 990 may include hook and loop tabs/straps, solid loops sewn into coat 820 (similar to belt loops on pants), straps with buttons or snaps, hook and loop fields on portions of rescue strap 910 that mate with hook and loop fields secured to coat 820, or the like.

FIG. 10 illustrates a user 1030 using a rescue strap 1010 engaged with a victim 1032's drag handle (not shown). Rescue strap 1010 extends from a cuff 1022 of an outer sleeve 1064 surrounding user 1030's first arm 1023, passes through victim 1032's drag handle (not shown), and encircles the wrist of user 1030's first arm 1023 with a wrist loop 1024. End strap 1014 may include a tri-glide buckle 1026 and buckle 1027 to effect the adjustment of the length of end strap 1014.

The advantage of the use of rescue strap 1010 as depicted in FIG. 10 is that this arrangement is a more secure and less physically demanding method for dragging victim 1032 using one arm (first arm 1023), leaving user 1030's other arm, if usable, to aid in pulling user 1030 and victim 1032 (e.g., along a rescue rope, stair handrail, and the like), open doors, cover a threat (where user 1030 has a weapon), and the like. The alternative, when using only one hand, is for user 1030 to grasp victim 1032's drag handle, which relies on the grip strength of user 1030's single hand, and which is of course physically demanding and exhaustive.

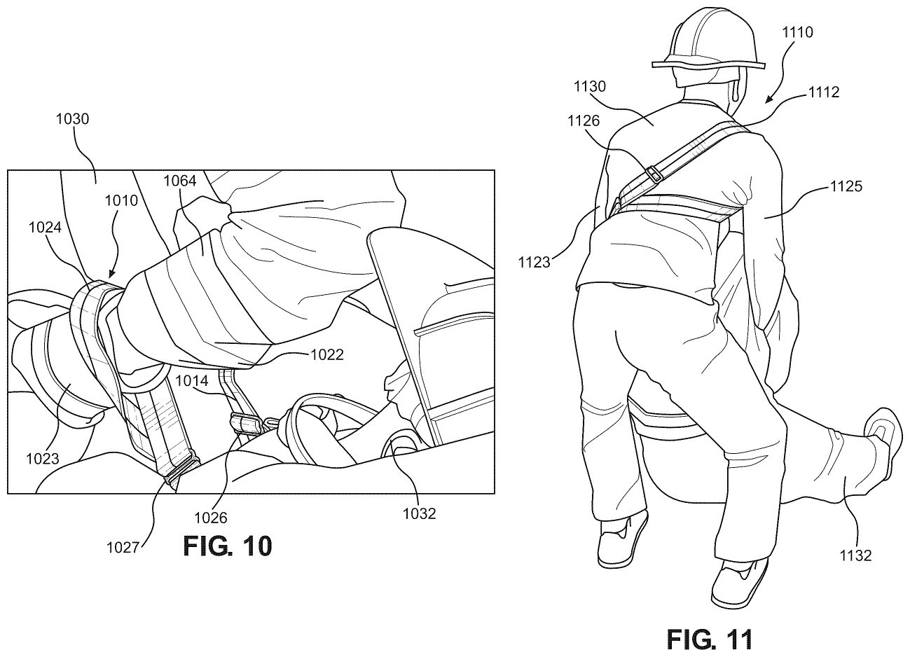

FIG. 11 illustrates a rear view of a user 1130 using a rescue strap 1110 to maintain a more secure and less exhausting grip around the torso of a victim 1132. Rescue strap 1110 includes a shoulder loop 1112 encircling user 1130's second arm 1125, and an end strap extending therefrom and along at least a portion of user 1130's first arm 1123. The end strap includes a wrist loop (not shown) which encircles the wrist of user 1130's second arm 1125. Shoulder loop 1112 may include a tri-glide buckle 1126 as described above. As illustrated in FIG. 11, it is not necessary that user 1130 wear a coat or other long sleeve garment when using rescue strap 1110, but in this arrangement, rescue strap 1110 cannot be stowed in, and does not extend out of, user 1130's cuff as it does when used with a coat or other long sleeve garment.

While coat 220, 420, 520, 620, 720, and 820 described herein are indicated as being coats, it is intended that such items could be substituted for any garment worn on a user's upper body, including those garments with sleeves terminating at or near the wearer's wrists, to include without limitation, long-sleeved shirts, sweatshirts, jackets, coats, and the like.

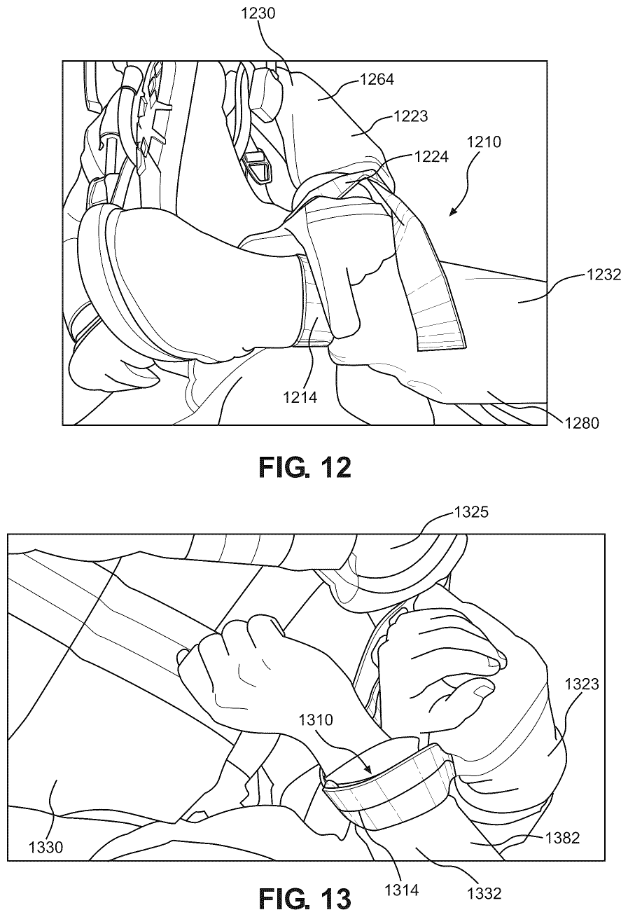

FIG. 12 illustrates a user 1230 using a rescue strap 1210 engaged with a victim 1232's leg 1280. The deployment of rescue strap 1210 illustrated in FIG. 12 is similar to the deployment of rescue strap 1110 illustrated in FIG. 11, except that rather than end portion extending through victim 1132's drag handle, end portion is extending around victim 1232's ankle of leg 1280. End strap 1214 exits an outer sleeve 1264 covering a first arm 1223, extends around victim 1232's leg 1280, and end strap 1214's wrist loop 1224 encircles the wrist of user 1230's first arm 1223.

FIG. 13 illustrates a user 1330 using a rescue strap 1310 engaged with a victim 1332's arms 1382. An end strap 1314 extends from a user 1330's first arm 1323, around the wrist of victim 1332's arms 1382, and end strap 1314's wrist loop (not shown) encircles the wrist of user 1330's second arm 1325. This arrangement allows user 1330 to drag victim 1332 by victim 1332's arms 1382, using both of user 1330's arms.

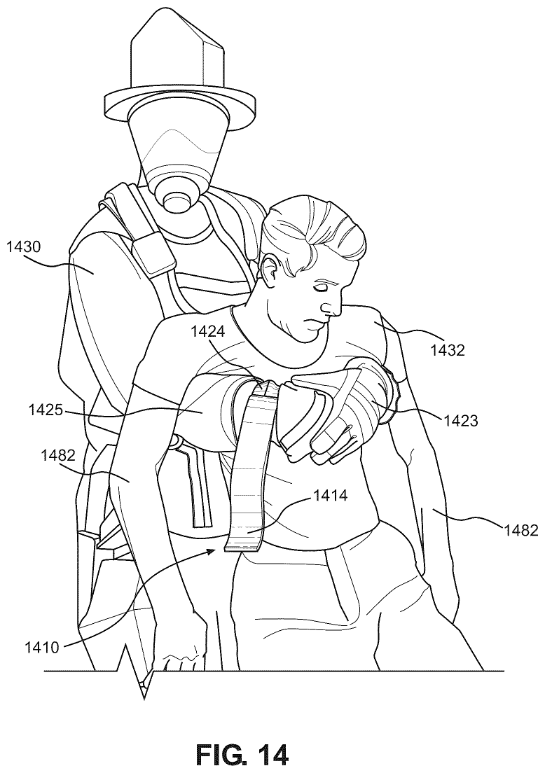

FIG. 14 illustrates rescue strap 1410 in a deployed state, extending from first arm 1423, and encircling the wrist of a second arm 1425, allowing the user 1430 to maintain a more secure and less exhausting grip around the torso of a victim 1432. User 1430's first arm 1423 and second arm 1425 extend under victim 1432's arms 1482. A wrist loop 1424 of an end strap 1414 encircles the wrist of user 1430's second arm 1425.

It is understood that some of the proximal shoulder loops described herein (e.g., shoulder loops 212, 312, 712, 912, and 1112) may be adjusted in size (e.g., by tri-glide 758, 958) by a user to accommodate users of varying sizes. Alternatively, it is understood that some of the proximal shoulder loops described herein are fixed in size. However, outside of intentional and deliberate adjustment by a user, none of the proximal shoulder loops described herein (e.g., shoulder loops 212, 312, 712, 912, and 1112) are intended to tighten or loosen. Stated differently, none of the proximal shoulder loops described herein (e.g., shoulder loops 212, 312, 712, 912, and 1112) are designed to cinch down in circumference upon application of a force upon the distal end strap in a direction away from the proximal shoulder loop, or increase circumference upon application of a force upon the distal end strap in a direction toward the proximal shoulder loop.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1-6. (canceled)

7. A rescue strap configured to be worn by a human user for transporting a human victim, comprising:
a proximal shoulder loop;
a distal end strap extending from the proximal shoulder loop, the distal end strap including a distal wrist loop and at least one securing mechanism,
wherein the distal wrist loop is configured to encircle the user's second arm at the second arm's wrist;
the distal end strap is configured to extend from a user's first wrist, along the user's first arm, across the user's back, and to the proximal shoulder loop;
the proximal shoulder loop is configured to encircle the user's second arm at the second arm's shoulder and under the second arm's armpit.

8. The rescue strap of claim 7, wherein the proximal shoulder loop includes a tri-glide buckle to adjust the size of the proximal shoulder loop.

9. The rescue strap of claim 7, wherein the distal end strap includes a tri-glide buckle to adjust the length of the distal end strap.

10. The rescue strap of claim 7, wherein the securing mechanism includes a hook and loop field attached to the distal end strap.

11. The rescue strap of claim 7, wherein the securing mechanism includes two magnets attached to and spaced apart from one another along a portion of the distal end strap.

12. The rescue strap of claim 7, wherein the securing mechanism includes one or more bendable or spring wires.

13. (canceled)

14. A rescue strap configured to be worn by a human user wearing a garment, comprising:
a proximal shoulder loop;
a distal end strap extending from the proximal shoulder loop, the distal end strap including a distal wrist loop and at least one securing mechanism,
wherein the securing mechanism includes two magnets attached to and spaced apart from one another along a portion of the distal end strap, wherein the two magnets are configured to engage one another through a user's garment sleeve cuff;
the distal end strap is configured to extend from the user's first wrist at the user's garment sleeve cuff, along the user's first arm inside the user's garment sleeve, across the user's back under the user's garment, and to the proximal shoulder loop; and
the proximal shoulder loop is configured to encircle the user's second arm under the user's garment at the second arm's shoulder and under the second arm's armpit.

15. The rescue strap of claim 14, wherein the proximal shoulder loop includes a tri-glide buckle to adjust the size of the proximal shoulder loop.

16. The rescue strap of claim 14, wherein the distal end strap includes a tri-glide buckle to adjust the length of the distal end strap.

17-19. (canceled)

20. The rescue strap of claim 14, wherein the distal wrist loop is configured to encircle the user's second arm at the second arm's wrist.

21. The rescue strap of claim 14, wherein the distal end strap is configured to extend outside of the user's garment sleeve cuff at or near the user's first wrist.

22. A garment configured to be used with a rescue strap worn by a human user, comprising:
an outer layer;
wherein the outer layer includes one or more outer sleeve, each outer sleeve having an outer cuff;
wherein the garment is configured to be used with a rescue strap having:
a proximal shoulder loop;
a distal end strap extending from the proximal shoulder loop, the distal end strap including a distal wrist loop;
the distal end strap configured to extend from the outer sleeve near the user's first wrist area, along the user's first arm, across the user's back, and to the proximal shoulder loop;
the proximal shoulder loop configured to encircle the user's second arm at the second arm's shoulder and under the second arm's armpit.

23. The garment configured to be used with a rescue strap worn by a human user of claim 22, wherein the proximal shoulder loop includes a tri-glide buckle to adjust the size of the proximal shoulder loop.

24. The garment configured to be used with a rescue strap worn by a human user of claim 22, wherein the distal end strap includes a tri-glide buckle to adjust the length of the distal end strap.

25. The garment configured to be used with a rescue strap worn by a human user of claim 22, wherein the securing mechanism includes a hook and loop field attached to the distal end strap configured to engage a hook and loop field attached to the outside of the user's outer cuff.

26. The garment configured to be used with a rescue strap worn by a human user of claim 22, wherein the securing mechanism includes two magnets attached to and spaced apart from one another along a portion of the distal end strap, wherein the two magnets are configured to engage one another through the user's outer cuff.

27. The garment configured to be used with a rescue strap worn by a human user of claim 22, wherein the securing mechanism includes one or more bendable or spring wires that are configured to clamp down onto the user's outer cuff.

28. The garment configured to be used with a rescue strap worn by a human user of claim 22, wherein the distal wrist loop is configured to encircle the user's second arm at the second arm's wrist.

29. The garment configured to be used with a rescue strap worn by a human user of claim 22, wherein the garment further comprises an inner layer, wherein the inner layer includes one or more inner sleeve, each inner sleeve having an inner cuff, and wherein the distal end strap is between the inner sleeve and the outer sleeve and across the user's back between the inner layer and the outer layer of the garment.

30. The garment of claim 29, wherein the proximal shoulder loop is between the inner layer and the outer layer of the garment.
